(19) United States
(12) Patent Application Publication
(10) Pub. No.: US 2025/0374966 A1
(43) Pub. Date: Dec. 11, 2025

(54) VAPING TANK DEVICES AND ATOMIZER FOR VAPING TANK DEVICES

(71) Applicant: KMM Technology, Incorporated, Ontario, CA (US)

(72) Inventor: Maury D. Cole, San Diego, CA (US)

(21) Appl. No.: 19/310,671

(22) Filed: Aug. 26, 2025

Related U.S. Application Data
(63) Continuation-in-part of application No. 17/369,865, filed on Jul. 7, 2021, now abandoned.
(60) Provisional application No. 63/049,023, filed on Jul. 7, 2020.

(51) Int. Cl. A24F 40/46; A24F 40/10; A24F 40/44; A24F 40/485; H05B 3/14

(52) U.S. Cl. CPC A24F 40/46; A24F 40/44; A24F 40/485; H05B 3/141; A24F 40/10; H05B 2203/021

(57) ABSTRACT

Vaping tanks and atomizers for vaping tanks are provided herein. Atomizers may include replaceable wick components and optionally be made entirely or partially of ceramic. Vaping tanks may include various components made entirely or partially of ceramic to reduce the risk of burning the user or the e-vaping liquid it burns.

### CROSS-REFERENCE TO RELATED APPLICATIONS

This application is a continuation-in-part of U.S. patent application Ser. No. 17/369,865 entitled “VAPING TANK DEVICES AND ATOMIZER FOR VAPING TANK DEVICES,” filed Jul. 7, 2021, which claims priority to U.S. Provisional Application No. 63/049,023, filed Jul. 7, 2020, the contents of both which are hereby incorporated by reference in their entirety.

### FIELD OF THE INVENTION

The field of the invention is vaping tank devices and atomizers for vaping tank devices.

### BACKGROUND

Electronic vaping devices are used to vaporize liquids for inhalation. E-vaping devices (or “vaping devices”) may be used for personal consumption, for example as an electronic cigarette, as well as for research and investigatory purposes, for example those described in International Application Publication WO 2019/204126 to Maury D. Cole. This and all other references are incorporated herein in their entireties.

With the widespread use of vaping devices, safety is an important issue. One safety concern with vaping devices is that vape tanks can get extremely hot, which can lead to a burnt taste or even burning of the user's lips or hands. Cost is also an important consideration as vape tanks and atomizers (or atomizer heads) periodically need to be replaced with leakage, contamination or compromised taste.

The present disclosure is directed toward overcoming one or more of the above problems and other improved features that identified below.

### SUMMARY

The present invention is directed to an atomizer for a vaping tank comprising a mouthpiece, a shell component, one or more wick components, and a base component with one to three chambers each containing heating coils. This vaping tank in a preferred embodiment has three chambers and is made of both ceramic and glass. These custom designed chambers are engineered specifically for research applications required for controlling and simultaneously administering multiple substances at one time. The wick components are removable and replaceable from within the shell and base components. In some embodiments, the shell component and the base component are entirely made of a heat resistant ceramic that cools down quickly. Additionally or alternatively, the body of the wick component (the wick component without the wick(s) and coil(s)) may be entirely made of ceramic. Ceramic wick(s) may also be provided, as well as mesh or wire wicks, among others. One or more of the shell component, the wick component and the base component may lack threads and couple to one another via a push and turn lock (or press fit) with a compressed and tight fit, optionally with an o-ring or other gasket. However, atomizers with threaded parts are also contemplated herein. The atomizers contemplated herein can advantageously be used with wick components of different electrical resistances. For example, a user may switch out a 0.35 ohm wick component with a 0.2 ohm wick component, a 0.35 ohm wick component with a 0.15 ohm wick component, a 0.2 ohm wick component with a 0.35 ohm wick component, a 0.2 ohm wick component with a 0.15 ohm wick component, a 0.15 ohm wick component with a 0.2 ohm wick component, a 0.15 ohm wick component with a 0.35 ohm wick component, and so forth, while using the same shell and base components. The shell component, the base component, and a set of wick components having different or the same electrical resistances can be provided as a kit. The wick or coil can be replaceable while using the same body of a wick component.

The inventive subject matter also comprises a vaping tank that is made entirely or almost entirely of ceramic (e.g., at least 50% ceramic, at least 60% ceramic, at least 70% ceramic, at least 80% ceramic, at least 90% ceramic, at least 98% ceramic). The vaping tank may also have a glass component just below the mouthpiece or atomizer. The vaping tank may comprise a base, an atomizer, a chimney, an air flow controller (optionally with a micrometer setting), and a top cap (and any other suitable component(s)). It is contemplated that each of the base, the atomizer or mouthpiece, the chimney, the air flow controller (optionally with a micrometer setting), and the top cap can be made in part or entirely of ceramic. In some embodiments, the entire vaping tank is made entirely of a heat resistant ceramic other than the wick(s) (e.g., a cotton), coil(s) (e.g., a wire) and optionally the base connector of the atomizer. Such vaping tanks advantageously eliminate or at least substantially reduce the risk of burning, or improve taste for a user.

The interior of the vaping tank is comprised of one or more chambers. In a preferred embodiment the vaping tank has three chambers. These internally divided chambers are distinct and can be ¼ inch compartments. These individual chambers allow for the separation of the compounds which are being tested. The compounds in each chamber can be simultaneously vaporized. A single ceramic heating element heats all three sections evenly. Each internal chamber also includes two vertical heating coils which allow for efficient and uniform vapor generation. Vertical heating coils are an improvement over the standard horizontal heating coils of existing vaping tanks. Each coil can be toped with a rounded ceramic or silicone bead to prevent injury or discomfort during product loading. Fresh air is introduced via angled airports from beneath the chamber. These airports create a cyclonic airflow that wraps around the inner walls. The vortex-like motion helps oxygenate the chamber, promoting even thermal distribution, complete combustion or vaporization, and minimizing residue

In a preferred embodiment the tank height is 2 and ⅜ inches in height which allows for maximum loading volume per chamber without sacrificing airflow or form factor. The vaping tank can have a thread base for connecting it. In a preferred embodiment the thread base is a 510-thread base for universal device integration.

Other advantages and benefits of the disclosed system and methods will be apparent to one of ordinary skill with a review of the following description.

### BRIEF DESCRIPTION OF THE DRAWINGS

The details of embodiments of the present disclosure, both as to their structure and operation, can be gleaned in part by study of the accompanying drawings, in which like reference numerals refer to like parts, and in which:

FIG. 1 illustrates an exploded view of an example vaping tank, in accordance with embodiments disclosed herein.

FIGS. 2 and 3 illustrate different views of the example vaping tank of FIG. 1.

FIG. 4 illustrates an example atomizer, in accordance with embodiments disclosed herein.

FIGS. 5 and 6 illustrate additional views of the atomizer of FIG. 4.

FIG. 7 illustrates an example hose barb mouthpiece, in accordance with embodiments disclosed herein.

FIG. 8 illustrates an exploded view of another example vaping tank, in accordance with embodiments disclosed herein.

FIG. 9 illustrates an exploded view of another example vaping tank, in accordance with embodiments disclosed herein; and

FIG. 10 illustrates a cross-sectional view of a three-chamber vaping tank with a mouthpiece and a thread base.

### DETAILED DESCRIPTION

The detailed description set forth below, in connection with the accompanying drawings, is intended as a description of various embodiments and is not intended to represent the only embodiments in which the disclosure may be practiced. The detailed description includes specific details for the purpose of providing a thorough understanding of the embodiments. However, it will be apparent that those skilled in the art will be able to understand the disclosure without these specific details. In some instances, well-known structures and components are shown in simplified form for brevity of description. Some of the surfaces have been left out or exaggerated for clarity and ease of explanation.

The present disclosure is directed to improved atomizers and vaping tanks that provide benefits such as reduced replacement needs, improved vaping experience, and reduced or eliminated instances of burning of a user, the vaping liquid, or taste.

Vaping tanks are used to hold a liquid and produce a vapor from the liquid. Known vaping tanks can include a drip tip, a top cap, an upper glass holder with an o-ring, a glass pipe, a chimney (e.g., top fill chimney, bottom fill chimney), a lower glass holder, an atomizer (with wick and coil), an air flow adjustment ring, and a base with a 510 connector. Such components and any other suitable components for vaping tanks are contemplated herein.

The glass pipe or outer tube is often a glass to allow visibility to liquid contained between the top cap and base. O-rings may be provided around one or more components such as the top cap and base, which (a) provide a seal between components when coupled to one another to prevent leakages, or (b) slides to expose or cover air flow holes, allowing selection of how loose or right a user's inhale will be. In some vaping tanks, the top cap may have a door that is removable or opens via a hinge to allow users to refill the vaping tank with a vaping liquid. The base generally includes a 510 thread screw adapter, which makes the electronic connection with a vape pen or other device having a battery. The atomizer includes a coil (generally a wire or mesh) and a wicking material (e.g., cotton) that draws liquid from the tank to the coils where it is heated into vapor. The atomizer can include a housing that is screwed into the tank's base.

There are numerous types of vaping tanks, including for example, sub Ohm tanks, mouth to lung tanks, rebuildable dripping atomizers (RDAs), rebuildable tank atomizers (RTAs), rebuildable dripping tank atomizers (RDTAs), dry herb tanks, and wax atomizers. Vaping tanks can be designed to be filled in different ways, including top-fill vaping tanks and bottom-fill vaping tanks.

It is contemplated that the atomizers and other vapor tank components disclosed herein can be used with any suitable vaping tanks and vaping devices now known or later discovered.

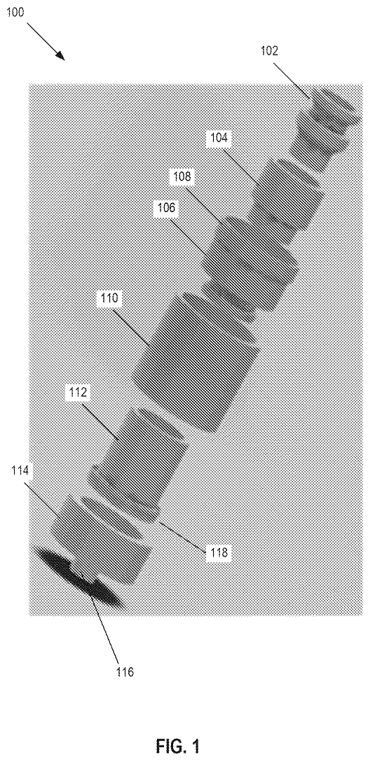

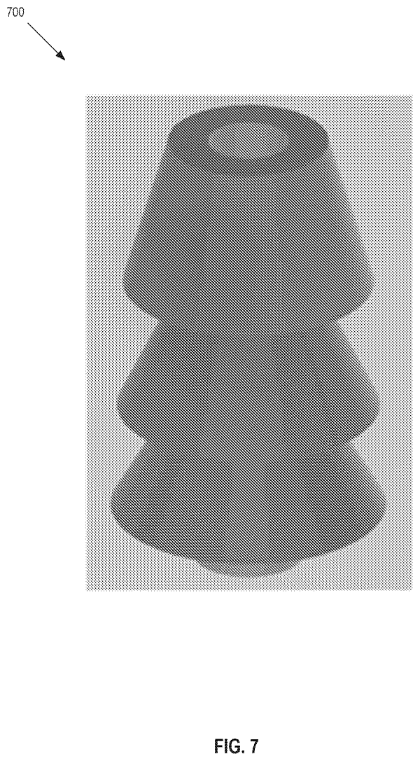

FIG. 1 illustrates an exploded view of an embodiment of a vaping tank 100, in accordance with embodiments disclosed herein. The vaping tank includes a drip tip 102 (replaceable with a hose barb mouthpiece of other vapor delivery component as described below in connection to FIG. 7), a top cap 104, a chimney 106, an air flow controller 108, a tube 110 formed of glass or material (e.g., plastic, metal, etc.), an atomizer 112, and a base 114 with a connector 116. In some contemplated embodiments, two or more of the components of a vaping tank may be combined to form a unitary component.

A drip tip 102 is a little hollow mouthpiece used as an alternative to cartridges and cartomizers. When using a drip tip 102, a user can pour or drip the e-liquid directly into the atomizer 112 without removing other components. The drip tip 102 couples with the top cap 104, and the top cap 104 couples with at least one of an air flow controller 108 and chimney 106. The air flow controller 108 can be opened and closed to control air flow coming out of the top of the vaping tank 100. In some contemplated embodiments, a micrometer or other measuring device may be included, for example, on a top portion of the vaping tank 100 (e.g., coupled to the air flow controller 108 to form an air flow micrometer setting controller), which can include numbers or other reference points so that a user can determine how much the air flow controller 108 is open or closed. The micrometer or other measuring device may be provided, for example, as markings on the air flow controller 108 showing the degree that the airflow controller 108 is open or closed. Such a measuring device can allow a user to accurately measure at least one (or all) of the following: how much vapor is exiting/flowing out of the vaping tank, how much vapor is going into a chamber coupled to the vaping tank 100 via a hose or other connector 116, the air quality, and the air flow going into the chamber coupled to the vaping tank 100.

The chimney 106 may be positioned at least partially within the tube 110. The atomizer 112 may be positioned at least partially within the tube 110, and coupled with the base 114, which includes a connector 116 (e.g., a threading, or non-threaded connector that press-fits) for coupling the vaping tank with an electronic cigarette of other vaping device (not shown) having a power source such as a battery. An O-ring 118 maybe provide at the end of the atomizer 112 adjacent to the base 114 to provide a sealed fit (e.g., press-fit) upon coupling. In some embodiments, a threaded coupling may be used in the alternative or in combination with the O-ring 118. The base 114 with connector 116 can be sized and dimensioned to couple with various vaping pens and other devices, including for example, any device that fits with a vaping tank with a 510 thread.

Each of the components shown in FIG. 1 and describe above, other than the tube 110, can be made entirely or partially of a heat resistant ceramic. The components can be assembled together via a press fit or push and turn locking mechanism that does not require threads. Additionally or alternatively, one or more of the components can include threads as a coupling mechanism. In some embodiments, the base 114, chimney 106, air flow controller 108, top cap 104, and drip tip/mouthpiece 102 are each made entirely of ceramic. In some embodiments, the base 114, chimney 106, air flow controller 108, top cap 104, and drip tip/mouthpiece 102 are each made at least 90% of ceramic. In some embodiments, the base 114, chimney 106, air flow controller 108, top cap 104, and drip tip/mouthpiece 102 are each made at least 80% of ceramic. In some embodiments, the body of the atomizer 112 (e.g., the entire atomizer without wick(s) or coil(s)) is made entirely of ceramic. In some embodiments, the body of the atomizer 112 (e.g., the entire atomizer without wick(s) or coil(s)) is made a least 90% of ceramic. In some embodiments, the body of the atomizer 112 (e.g., the entire atomizer without wick(s) or coil(s)) is made at least 80% of ceramic. In some embodiments, some components of a vaping tank 100 are made entirely of ceramic while others are made partially of ceramic. In some contemplated embodiments, one or more components comprise no ceramic.

The vaping tank 100 can be sized to hold any suitable amount of liquid, including for example 5 ml or even 10 ml without the need for an adapter. In some embodiments, the vaping tank 100 may be configured to hold combustible plant material that is heated via the atomizer. For example, combustible plant material may be placed in the base 114 and/or in the atomizer 112.

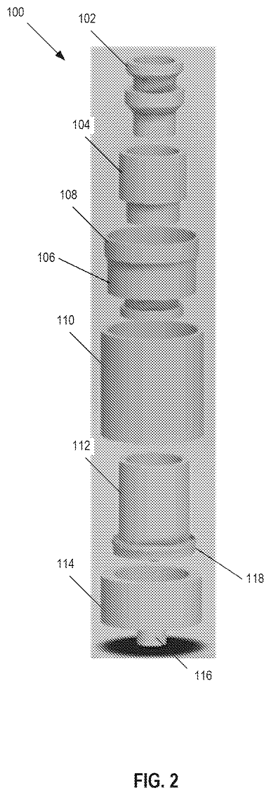

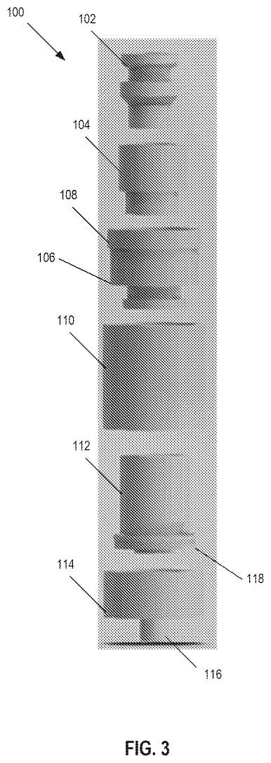

FIGS. 2 and 3 illustrate different views of the vaping tank of FIG. 1. FIG. 2 illustrates an exploded side perspective view of the vaping tank 100 and FIG. 3 illustrates an exploded side elevation view of the vaping tank 100.

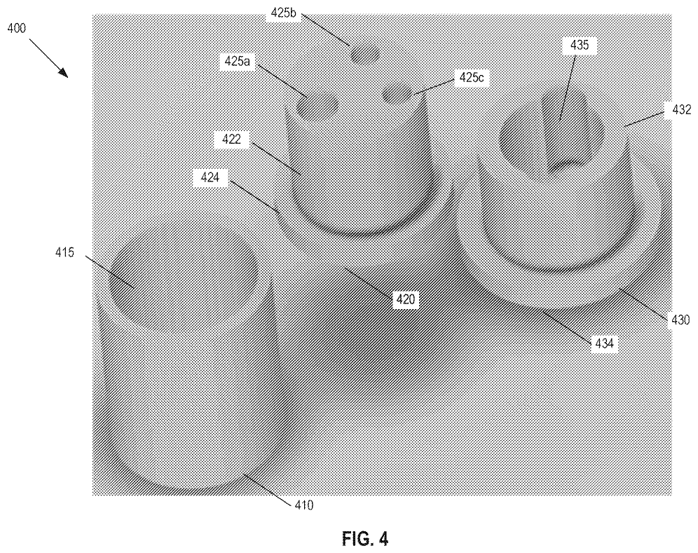

FIG. 4 illustrates an example atomizer 400, in accordance with embodiments disclosed herein. The atomizer 400 may be an example of atomizer 112 of FIG. 1. The atomizer 400 as a plurality of components. As shown in the FIG. 4, the components of the atomizer separated, and a wick or coil which can be inserted into the chambers (also referred to as channels) of the wick component are removed for illustrative purposes. The atomizer includes a shell component 410, an interchangeable wick component 420 (shown without wick or coil for illustrative purposes only), and a base component 430. The atomizer 400 is responsible for vaporizing e-liquid by converting energy from the vaping device (e.g., vaping tank 100) coupled to a includes a power source (e.g., a battery) via connected 116 and heating the wick/coil inside the atomizer 400 to vaporize the e-liquid soaked into the wicking/coil material.

The wick components can comprise one or more wick channels 420 (also referred to as wick chambers, chambers, or channels) for housing coil(s) and wicking material. For example, as shown in FIG. 4, wick component 420 comprises three channels 425a-425cm, however any suitable number of channels may be provided (e.g., 1, 2, 3, 4, 5, etc.). Each of the wick channels 425 may be have the same diameter or different diameters, for example, as shown in FIG. 4 channel 425a has a larger diameter than channel 425b and 425c (which may also be the same or different with respect to each other. Additionally, each wick channel need not have a circular opening but may be any suitable shape. For example, a mesh coil can be inserted into each of the wick channels 425 similarly to the way bullets are loaded into chambers of a revolver cylinder. The bottom of the wick component may attach or otherwise couple with the base component 430. That base component 430 may include a heating element (e.g., a resistive heating element or the like), to heat the coil(s) housed in channels 425. Advantageously, a user could remove and replace a coil or wick without removing other components of the vapor tank 100. Additionally, a user could remove and replace a wick component without replacing the shell component 410 or the base component 430.

It is contemplated that different wick components (e.g., wick component 420 being an illustrative example of a wick component) with different resistance of the wick/coil housed therein being used interchangeably with the same shell and base components 410, 430. The shell component 410 is an outer casing, and the base component 430 provides electrical contact to the coil and is provides the heating element of the atomizer. The wick component is insertable into the base component 430, and the shell component 410 surrounds the base component 430 or a portion thereof. When power is provided to the coil housed in the wick component 420, energy is converted to heat, which vaporizes the liquid from the saturated wicking material (e.g., liquid received via the drip tip 102 as describe above). The wicking material may be a cotton, silica rope or other material. The wicking material may surround or be inserted into the coil.

It is contemplated that the components of the atomizers 400 can be press fit to one another, or can push in and twist to lock together. In some contemplated embodiments, two or more components can couple to one another via threading.

Advantageously, atomizers in accordance with the present disclosure can comprise a universal fit and be used with Zeus™ and Smok™ top or bottom-fill/top or bottom air flow vaping tanks, among others. Further, atomizers disclosed herein do not need to be replaced in whole, and a user can simply replace a portion thereof, for example, the wick component 420 (or the wick material or coil material thereof).

The shell component 410, base component 430, and the wick component 420 can be made of any suitable material or materials. For example, the shell component 410, base component 420, and the wick component 430 can each be made entirely or partially of ceramic. In some embodiments, the entire atomizer may be made of ceramic other than the wicking material and coil inserted into the wick channels 425, and any electronic components within the base component 420.

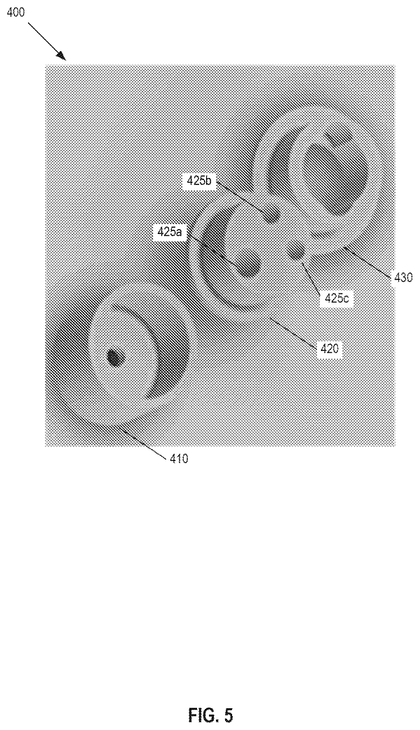

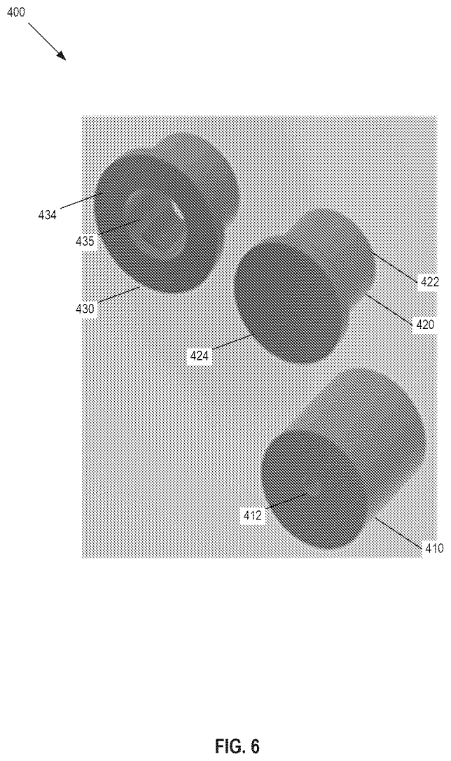

FIGS. 5 and 6 illustrate additional views of the atomizer of FIG. 4. FIG. 5 illustrates a perspective top down view of the components of atomizer 400 and FIG. 6 illustrates a perspective bottom up view of the components of atomizer 400.

As described above, the wick component is insertable into the base component 430, and the shell component 410 surrounds the base component 430 or a portion thereof. For example, with reference to FIGS. 4-6, a upper body portion 422 of the wick component 420 may be inserted into an opening 435 from the base portion 434 of the base component 430, such that base 424 of the wick component 420 contacts the base component 434 of the base component 430. The opening 435 is surrounded by an upper body portion 432 of the base component 430 comprising the heating element.

The shell component 410 comprises an opening 415 into which the base component 430 and the wick component 420 maybe inserted. For example, the coupled bases of the wick component 420 and base component 430 maybe inserted into the opening 415 facing the base of the shell component 410, with the upper body portions 422, 432 facing the open end of the opening 435. An opening 412 may be provided at the base of the shell component 410 through which the power source coupled to the vapor tank 100 via connector 116 may be connected to the heating element of the base component 420. Thus, in the illustrative example, the base 424 of the wick component 420 may be positioned between the base 434 of base component 430 and the shell component 410. Accordingly, the embodiments herein provide for removal and replacement of coil(s)/wick(s) housed in the wick component 420 without removing all of the other components of the vapor tank 100. Additionally, a user could remove and replace a wick component without replacing the shell component 410 or the base component 430.

FIG. 7 illustrates an example hose barb mouthpiece 700, in accordance an embodiment disclosed herein. Hose barb 700 may be an alternative to a drip tip such as the drip tip 102 shown in FIG. 1. Hose barb mouthpieces, such as hose barb mouthpiece 700, can be used for research purposes, for example, to study the effects of different substances on animals (among other things). The hose barb mouthpiece 700 may be sized and dimensioned such that a hose can be secured at least partially around it (e.g., a ¼ inch hose).

The hose barb mouthpiece 700 can couple with the top cap 104 of the vaping tank 100 of FIG. 1 in place of the drip tip 102. The hose barb mouthpiece 104 can be made of any suitable material or materials. For example, the hose barb mouthpiece may be made entirely of a ceramic.

In some embodiments, one or more spikes may be added to the bottom of the vaping tank disclosed herein. The spikes may thermally coupled to a power source (e.g., via connector 116 of FIG. 1) and/or the heating element of the atomizer such that the one or more spikes heat up. The one or more spikes may be configured to penetrate plant material and/or e-liquid housed in the vaping tank and, by heating the one or more spikes, the plant material and/or e-liquid is heated.

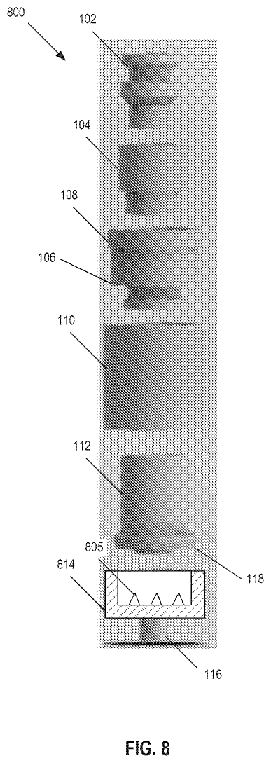

FIG. 8 illustrate an exploded view of another example vaping tank 800. The vaping tank 800 is substantially similar to vaping tank 100, except that one or more spikes 805 are positioned within base 814. The base 814 (shown FIG. 8 as a sectional view) may be substantially similar to base 114 of FIG. 1 aside from comprising one or more spikes 805. While three spikes are illustrated in FIG. 8, any suitable spikes may be included of any suitable length. The length of the spikes need only be long enough to penetrate the contents of the vaping tank so as to heat up and burn the contents therein.

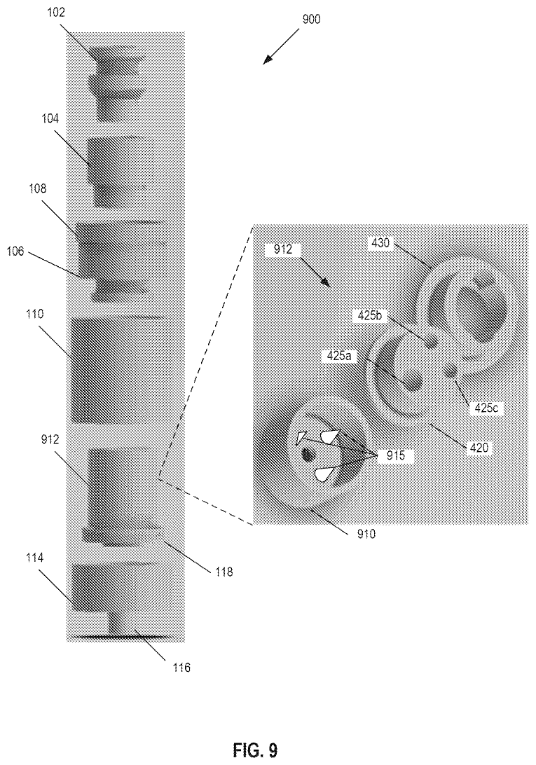

FIG. 9 illustrate an exploded view of another example vaping tank 900. The vaping tank 900 is substantially similar to vaping tank 100, except that atomizer 912 replaces atomizer 112 and 400. Atomizer 912 may be substantially the same as atomizer 112, except that one or more spikes 915 are added to shell component 910 (which is substantially similar to shell component 410). As described above, the one or more spikes 915 may be heated up so as to apply heat to contents in the atomizer 912. While three spikes are illustrated in FIG. 9, any suitable spikes may be included of any suitable length. The length of the spikes need only be long enough to penetrate the contents of the vaping tank so as to heat up and burn the contents therein.

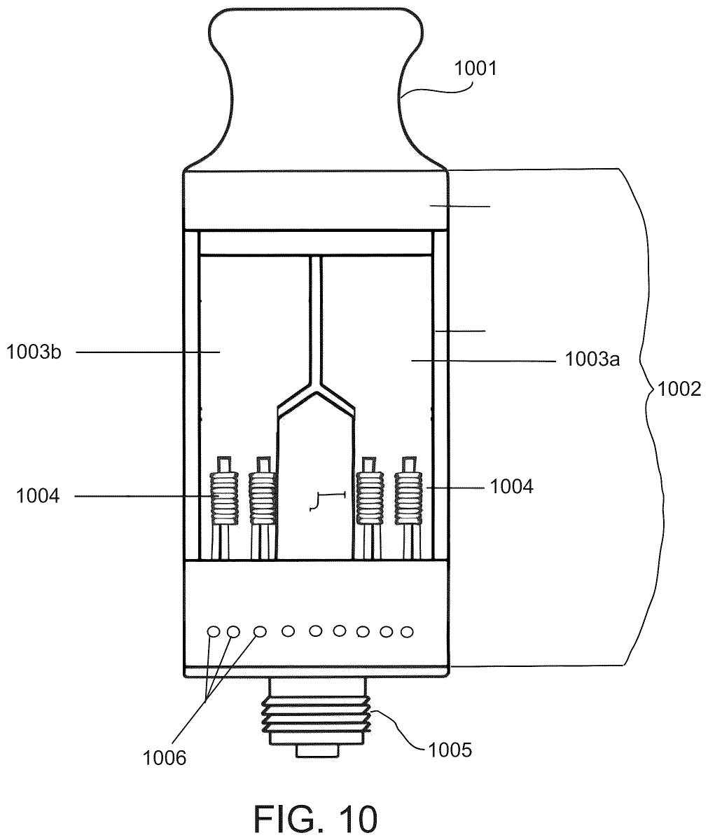

FIG. 10 illustrates a cross-sectional view of a three-chamber vaping tank with a mouthpiece and a thread base. The three-chamber vaping tank includes a mouthpiece 1001, a body 1002 with three internal chambers 1003 (a) and 1003 (b) (only two can be seen from the cross-section view). Each chamber 1003 (a) and 1003 (b) has two ceramic coils 1004 for a total of six coils. The body has a 510-thread base 1005 so that it can be coupled to other devices. The mouthpiece 1001 has an opening which can be extra wide from 0.8 to 1.5 inches to allow for increased airflow and vapor delivery. The inner side of the tank 1002 can be made of high-grade ceramic to allow for clean and inert vaporization. A single ceramic heating element is centrally located to heat all three chambers equally. In a preferred embodiment the vaping tank is between 2 and 3 inches high, with an ideal height of 2⅜ inches to allow maximum loading volume per chamber without sacrificing airflow.

Each internal chamber include two vertical ceramic coils 1004 which allow for efficient and uniform vapor generation. Vertical heating coils are an improvement over the standard horizontal heating coils of existing vaping tanks. Each coil 1004 can be toped with a rounded ceramic or silicone bead to prevent injury or discomfort during product loading. Fresh air is introduced via angled airports from beneath the chamber. These airports create a cyclonic airflow that wraps around the inner walls. The vortex-like motion helps oxygenate the chamber, promoting even thermal distribution, complete combustion or vaporization, and minimizing residue

In another example, a vaping tank may be provided that is similar to vaping tank 100 and includes both base 814 and atomizer 912 to provide multiple sets of spikes. Thereby decreasing the time necessary to burn plant material and/or vaporize e-liquid.

Thus, various embodiments of vape tanks have been described. Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more.

As used herein, and unless the context dictates otherwise, the term “coupled to” is intended to include both direct coupling (in which two elements that are coupled to each other contact each other) and indirect coupling (in which at least one additional element is located between the two elements).

The recitation of ranges of values herein is merely intended to serve as a shorthand method of referring individually to each separate value falling within the range, and including the endpoints. Unless otherwise indicated herein, each individual value is incorporated into the specification as if it were individually recited herein.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “assembly,” “mechanism,” “element,” “device,” and the like may not be a substitute for the word “means.” As such, no claim element is to be construed as a means plus function unless the element is expressly recited using the phrase “means for.”

The accompanying claims and their equivalents are intended to cover such forms or modifications as would fall within the scope of the disclosure. The features and attributes of the specific example embodiments of the vape tanks disclosed above may be combined in different ways to form additional embodiments, all of which fall within the scope of the disclosure.

Although the present disclosure provides certain example embodiments and applications, other embodiments that are apparent to those of ordinary skill in the art, including embodiments which do not provide all of the features and advantages set forth herein, are also within the scope of this disclosure.

it is to be understood that the above description is not intended to limit the scope of these embodiments. While embodiments and variations of the many aspects of the invention have been disclosed and described herein, such disclosure is provided for purposes of explanation and illustration only. Thus, various changes and modifications may be made without departing from the scope of the claims. For example, not all of the components described in the embodiments are necessary, and the invention may include any suitable combinations of the described components, and the general shapes and relative sizes of the components of the invention may be modified. Accordingly, embodiments are intended to exemplify alternatives, modifications, and equivalents that may fall within the scope of the claims. The invention, therefore, should not be limited, except to the following claims, and their equivalents.

Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Further, any reference to claim elements in the singular, for example, using the articles “a,” “an,” or “the” is not to be construed as limiting the element to the singular.

The previous description is provided to enable any person skilled in the art to practice the various aspects described herein. Various modifications to these aspects will be readily apparent to those skilled in the art, and the generic principles defined herein may be applied to other aspects.

Thus, the claims are not intended to be limited to the aspects shown herein, but are to be accorded the full scope consistent with the language claims, wherein reference to an element in the singular is not intended to mean “one and only one” unless specifically so stated, but rather “one or more.”

Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C.

What is claimed is:

1. An atomizer for a vaping tank, comprising:
a shell component, a wick component, and a base component, wherein each of the shell component, the wick component, and base components can be removably coupled to one another; and
wherein the wick component is removable and replaceable.

2. The atomizer of claim 1, wherein the shell component and the base component are entirely made of ceramic.

3. The atomizer of claim 2, wherein a body of the wick component is made entirely of ceramic.

4. The atomizer kit, comprising:
the atomizer of claim 1; and
a second wick component of different electrical resistance than the wick component.

5. A vaping tank, comprising:
a mouthpiece, a body and a thread base
the body comprising three chambers each having two ceramic coils and a single ceramic heating element,
wherein each of the mouthpiece, body and thread base is made at least in part from a ceramic.

6. The vaping tank of claim 5, wherein the tank is between 2 and 3 inches in height.

7. The vaping tank of claim 5, wherein the mouthpiece has an opening of 0.8 to 1.5 inches.

8. The vaping tank of claim 5, wherein the air flow controller comprises a micrometer setting.

9. An atomizer for a vaping tank, comprising:
a shell component, a wick component, and a base component removably coupled to one another; and
one or more spikes,
wherein the wick component is removable and replaceable.

10. The atomizer of claim 8, wherein the shell component comprises the one or more spikes.

11. A vaping tank, comprising:
a base, an atomizer, a chimney, an air flow controller, and a top cap; and
one or more spikes disposed within the vaping tank,
wherein each of the base, the atomizer, the chimney, the air flow controller, and the top cap is made at least in part from a ceramic.

12. The vaping tank of claim 9, wherein the base comprises the one or more spikes.

13. The vaping tank of claim 9, wherein the atomizer comprises the one or more spikes.
